(19) United States
(12) Patent Application Publication
(10) Pub. No.: US 2005/0219157 A1
(43) Pub. Date: Oct. 6, 2005

(54) Method and apparatus for driving display panel

(76) Inventor: Joo-Yul Lee, Asan-si (KR)

Correspondence Address: MCGUIREWOODS, LLP, 1750 TYSONS BLVD, SUITE 1800, MCLEAN, VA, 22102, US

(21) Appl. No.: 11/030,202

(22) Filed: Jan. 7, 2005

(30) Foreign Application Priority Data
Mar. 30, 2004 (KR) 2004-0021551

(51) Int. Cl. G09G 3/28

(52) U.S. Cl. 345/63

(57) ABSTRACT

There is provided a display panel driving method, which groups display cells included in scanning electrodes and common electrodes into a plurality of groups, and divides and drives a frame into a plurality of sub-fields for each group. Each of the plurality of sub-fields includes an address period and a sustain period. In the address period, cells to be displayed are selected, while in the sustain period, high levels and low levels of a sustain discharge signal are applied alternately to the scanning electrodes and the common electrodes to perform a sustain discharge. In at least one sustain period, high level potentials of the sustain discharge signal applied to the scanning electrode are the same in all the groups and the high level potentials of the sustain discharge signal are applied at the same time to all the groups. Further, low level potentials of the sustain discharge signal applied to the scanning electrodes include a first low level potential and a second low level potential higher than the first low level potential. In addition, the first low level and the second low level potentials are applied to each of the groups at different times. Therefore, it is possible to group display cells into a plurality of groups and drive each of the groups individually without an additional driving circuit.

This application claims the priority of Korean Patent Application No. 2004-21551, filed on Mar. 30, 2004, in the Korean Intellectual Property Office, the disclosure of which is incorporated herein by reference in its entirety.

### BACKGROUND OF THE INVENTION

1. Field of the Invention

The present invention relates to a display panel, such as a plasma display panel (PDP), which displays an image by sequentially using an address period and a sustain period, and more particularly, to a display panel driving method and apparatus which group display cells into a plurality of groups and drive each of the groups individually.

2. Background Description

FIG. 1 shows a structure of a conventional plasma display panel 1 with a 3-electrode surface discharge structure.

Address electrode lines A₁, A₂, . . . , Aₘ, dielectric layers 102 and 110, Y electrode lines Y₁, . . . , Yₙ, X electrode lines X₁, . . . , Xₙ, phosphor layers 112, partition walls 114, and an MgO layer 104, which is as a protection layer, are formed between front and rear glass substrates 100 and 106 of the conventional surface discharge plasma display panel 1.

The address electrode lines A₁, A₂, . . . , Aₘ are formed in a predetermined pattern on an upper surface of the rear glass substrate 106. The lower dielectric layer 110 covers the address electrode lines A₁, A₂, . . . , Aₘ. The partition walls 114 are formed on the surface of the lower dielectric layer 110 and parallel to the address electrode lines A₁, A₂, . . . , Aₘ. The partition walls 114 partition discharge areas of display cells and prevent optical interference between the display cells. The phosphor layers 112 are formed between each pair of adjacent partition walls 114.

The X electrode lines X₁, . . . , Xₙ and the Y electrode lines Y₁, . . . , Yₙ, constituting display electrode line pairs are formed in a predetermined pattern on a lower surface of the front glass substrate 100 in such a way as to intersect the address electrode lines A₁, A₂, . . . , Aₘ. Each of the intersections forms a corresponding display cell. Each of the X-electrode lines X₁, . . . , Xₙ and each of the Y-electrode lines Y₁, . . . , Yₙ are formed by coupling transparent electrode lines Xₙₐ and Yₙₐ, composed of a transparent conductive material such as ITO (Indium Tin Oxide) with metal electrode lines X_{nb} and Y_{nb} for enhancing conductivity. The upper dielectric layer 102 covers the X-electrode lines X₁, . . . , Xₙ and the Y electrode lines Y₁, . . . , Yₙ. A protection layer 104 for protecting the panel I in a strong electric field, such as a MgO layer, is formed on the rear surface of the upper dielectric layer 102. A discharge space 108 is filled with plasma-forming gas and is sealed up.

In a driving method generally applied to such a plasma display panel, an initialization period, an address period, and a display sustain period are sequentially used in a unit sub-field. The initialization period is required to uniformly distribute electric charges in all display cells to be driven. In the address period, a charge state of display cells to be selected and a charge state of display cells not to be selected are set. In the display sustain period, a display discharge is carried out in the display cells to be selected. In more detail, plasma is generated by plasma-forming gas in the display cells being subjected to the display discharge, and the phosphors 112 of the display cells are excited by ultraviolet emission from the plasma, thereby emitting a light.

FIG. 2 is a block diagram of a conventional driving apparatus for driving the conventional plasma display panel of FIG. 1. The conventional driving apparatus of the plasma display panel 1 includes an image processor 200, a controller 202, an address driving unit 206, a X driver 208, and a Y driver 204. The image processor 200 converts external analog image signals into digital signals and generates internal image signals, such as, for example, red (R), green (G), and blue (B) image signals. The image signals each have 8 bits, clock signals, and vertical and horizontal synchronization signals. The controller 202 generates driving control signals S_{A}, S_{Y}, and S_{X} in response to the internal image signals received from the image processor 200. The address driver 206 receives and processes the address signal S_{A} among the driving control signals S_{A}, S_{Y}, and S_{X} output from the controller 202, generates a display data signal, and transmits the display data signal to address electrode lines. The X driver 208 receives and processes the X driving control signal S_{X} among the driving control signals S_{A}, S_{Y}, and S_{X} output from the controller 202 and transmits the X driving control signal S_{X} to X electrode lines. The Y driver 204 receives and processes the Y driving control signal S_{Y} among the driving control signals S_{A}, S_{Y}, and S_{X} output from the controller 202 and transmits the Y driving control signal S_{Y} to Y electrode lines.

A method for driving the plasma display panel 1 with the above-described structure is disclosed in U.S. Pat. No. 5,541,618 describing an Address-Display Separation (ADS) driving method.

FIG. 3 is a view for explaining the conventional ADS driving method applied to Y electrode lines of the conventional plasma display panel of FIG. 1. A unit frame is divided into a predetermined number of sub-fields, such as, for example, 8 sub-fields SF1 through SF8, for time-division gray-scale display. Also, the sub-fields SF1, . . . , SF8 are divided into resetting periods (not shown), addressing periods A1, . . . , A8, and discharge sustain periods S1, . . . , S8, respectively.

During the respective addressing periods A1, . . . , A8, corresponding scanning pulses are sequentially transmitted to the respective Y electrode lines Y₁, . . . , Yₙ, while a display data signal is transmitted to the respective address electrode lines (A₁, A₂, . . . , Aₘ of FIG. 1). During the respective discharge sustain periods S1, . . . , S8, discharge sustain pulses are transmitted alternately to all the Y electrode lines Y₁, . . . , Yₙ and all the X electrode lines X₁, . . . , Xₙ, thus generating a display discharge in discharge cells that wall charges are formed in during the corresponding addressing periods A1, . . . , A8.

Accordingly, brightness of a plasma display panel is proportional to the number of total sustain discharge pulses within the discharge sustain periods S1, . . . , S8 included in a unit frame. If a frame forming an image consists of 8 sub-fields with 256 gray-scales, different sustain pulse numbers of 1, 2, 4, 8, 16, 32, 64 and 128 can be allocated to the respective sub-fields in this order. In this case, in order to obtain brightness with 133 gray-scales, it is needed to address and sustain-discharge cells during a first sub-field period SF1, a third sub-field period SF3, and an eighth sub-field period SF8.

The number of the sustain pulses allocated to each of the sub-fields can be set according to weight values of sub-fields on the basis of APC (Automatic Power Control). Also, the number of the discharge sustain pulses allocated to each of the sub-fields can be changed variously in consideration of gamma characteristics and/or panel characteristics. For example, decreasing a gray-scale allocated to the fourth sub-field SF4 from 8 to 6 and increasing a gray-scale allocated to the sixth sub-field SF6 from 32 to 34 is possible. Also, the number of sub-fields forming a frame can be changed variously according to a design rule.

FIG. 4 is and example of a timing diagram of driving signals used in the conventional plasma display panel of FIG. 1. The driving signals are applied to an address electrode A, a command electrode X and scanning electrodes Y₁ through Yₙ, within a sub-field SF, according to the ADS driving method of an AC PDP. Referring to FIG. 4, the sub-field SF includes a reset period PR, an address period PA and a sustain discharge period PS.

In the reset period PR, a reset pulse is applied to all scanning line groups to perform a compulsory write discharge, so that wall charges in entire cells are distributed uniformly. Since the reset period PR is provided prior to the address period PA and is performed throughout an entire screen, it is possible to form wall charges in a very uniform distribution. Therefore, the wall charges in all the cells initialized in the reset period PR are maintained under a similar condition. After the reset period PR ends, the address period PA starts. During the address period PA, a bias voltage Ve is applied to the common electrode X to simultaneously turn on scanning electrodes Y₁ through Yₙ and address electrodes A₁ through Aₘ including cells to be displayed, thereby selecting display cells. After the address period PA ends, the sustain discharge period PS starts. During the sustain discharge period PS, a sustain pulse V_{S} is applied alternately to the common electrode X and the scanning electrodes Y₁ through Yₙ, and a voltage V_{G} (for example, ground voltage) with a low level is applied to the address electrodes A₁ through Aₘ. Brightness of the PDP is controlled according to the number of the sustain discharge pulses. As the number of the sustain discharge pulses included in a sub-field or in a TV field increases, the brightness of the PDP becomes higher.

In conventional ADS driving methods, the high level and low level of the sustain discharge signal which are applied alternately to the scanning electrodes and the common electrode in the sustain period PS, are fixed to predetermined values. Thus, in order to group display cells into a plurality of groups and drive each group individually according to such a conventional ADS driving method, separate driving circuits for each of the groups are required, which increases equipment cost.

Also, the above-described ADS driving method performs a sustain discharge operation for all the cells of the corresponding scanning electrodes Y₁ through Yₙ at the same time after terminating addressing of all the first through final scanning electrodes Y₁ through Yₙ. According to the conventional ADS driving method, after an addressing operation of a scanning line is performed, a sustain discharge operation of the corresponding scanning line is performed after an addressing operation of a final scanning line is performed. Accordingly, a larger temporal gap is generated until a sustain discharge operation is performed in cells subjected to the addressing operation, which may make the sustain discharge operation unstable.

### SUMMARY OF THE INVENTION

The present invention provides a display panel driving method which groups display cells into a plurality of groups and drives each of the groups individually without an additional driving circuit.

The present invention also provides a display panel driving method which groups display cells into a plurality of groups and drives each of the groups individually without an additional driving circuit, in order to achieve stable sustain discharge by minimizing a temporal gap between an addressing period and a sustain period in implementing gray-scale.

The present invention also provides a display panel driving apparatus for performing the display panel driving method.

According to an aspect of the present invention, there is provided a display panel driving method which includes grouping display cells included in scanning electrodes and common electrodes into a plurality of groups, and dividing and driving a frame into a plurality of sub-fields for each group, wherein, each of the plurality of sub-fields includes an address period and a sustain period. Further, in the address period, cells to be displayed are selected, and in the sustain period, high levels and low levels of a sustain discharge signal are applied alternately to the scanning electrodes and the common electrodes so to perform a sustain discharge. In addition, in at least one sustain period, high level potentials of the sustain discharge signal applied to the scanning electrode are the same in all the groups and the high level potentials of the sustain discharge signal are applied at the same time to all the groups; low level potentials of the sustain discharge signal applied to the scanning electrodes include a first low level potential and a second low level potential higher than the first low level potential.

According to an aspect of the present invention, there is provided a display panel driving method, which includes grouping display cells included in scanning electrodes and common electrodes into a plurality of groups, and dividing a frame into a plurality of sub-fields for each group, wherein, each of the plurality of sub-fields includes an address period and a sustain period. Further, in at least one of the plurality of sub-fields, the address period and the sustain period are performed sequentially to each group in a manner that: a) addressing of each the group is performed and then the sustain period is performed in cells of each the group subjected to addressing; b) addressing of cells of a different group is performed after the sustain period ends; and c) the sustain period is performed selectively in the cells of the different group subjected to addressing while the sustain period is performed in cells of a group. In addition, in at least one sustain period, high level potentials of the sustain discharge signal applied to the scanning electrode are the same in all the groups and the high level potentials of the sustain discharge signal are applied at the same time to all the groups; low level potentials of the sustain discharge signal applied to the scanning electrodes include a first low level potential and a second low level potential higher than the first low level potential.

According to another aspect of the present invention, there is provided a display panel driving apparatus, which applies a scanning signal and a sustain discharge signal to a scanning electrode line of a display panel. The apparatus including: a first node, a sustain driving unit, which is connected to the first node, a scanning signal high level applying unit, which is connected to the first node, and a scanning signal low level applying unit, which is connected to the first node. In addition, a first switch, whose one end is connected to the scanning signal high level applying unit; a second low level applying unit, which applies a second low level of a sustain discharge signal; a second switch, which is connected between the other end of the first switch and the second low level applying unit; a high level scanning switch, which is connected between the other end of the first switch and the scanning electrode line; and a low level scanning switch, which is connected between the scanning electrode line and the scanning signal low level applying unit.

According to still a further aspect of the invention, a computer-readable medium having embodied thereon a computer program for executing a display panel driving method is provided, where the medium includes code for grouping display cells included in scanning electrodes and common electrodes into a plurality of groups, code for dividing and driving a frame into a plurality of sub-fields for each group, wherein, each of the plurality of sub-fields includes an address period and a sustain period, code for, in the address period, selecting cells to be displayed and code for, in the sustain period, applying high levels and low levels of a sustain discharge signal alternately to the scanning electrodes and the common electrodes so to perform a sustain discharge. Further, in at least one sustain period, the high level potentials of the sustain discharge signal applied to the scanning electrode are the same in all the groups and the high level potentials of the sustain discharge signal are applied at the same time to all the groups, low level potentials of the sustain discharge signal applied to the scanning electrodes include a first low level potential and a second low level potential higher than the first low level potential.

An additional exemplary embodiment of the invention provides a computer-readable medium having embodied thereon a computer program for executing a display panel driving method, where the medium includes code for grouping display cells included in scanning electrodes and common electrodes into a plurality of groups, and code for dividing a frame into a plurality of sub-fields for each group, wherein each of the plurality of sub-fields includes an address period and a sustain period. Further, the medium includes code for, in at least one of the plurality of sub-fields, sequentially performing the address period and the sustain period to each group in a manner that a) addressing of each the group is performed and then the sustain period is performed in cells of each the group subjected to addressing, b) addressing of cells of a different group is performed after the sustain period ends, and c) the sustain period is performed selectively in the cells of the different group subjected to addressing while the sustain period is performed in cells of a group. During at least one sustain period, high level potentials of the sustain discharge signal applied to the scanning electrode are the same in all the groups and the high level potentials of the sustain discharge signal are applied at the same time to all the groups, low level potentials of the sustain discharge signal applied to the scanning electrodes include a first low level potential and a second low level potential higher than the first low level potential.

According to still another exemplary embodiment of the invention, a display panel driving method includes driving a frame into a plurality of sub-fields, wherein each of the plurality of sub-fields includes an address period and a sustain period, in the address period, selecting cells to be displayed, and in the sustain period, applying high levels and low levels of a sustain discharge signal alternately to scanning electrodes and common electrodes so to perform a sustain discharge, wherein in at least one sustain period, the high level potentials of the sustain discharge signal applied to the scanning electrode are the same and the high level potentials of the sustain discharge signal are applied at the same time and low level potentials of the sustain discharge signal applied to the scanning electrodes include a first low level potential and a second low level potential higher than the first low level potential.

### BRIEF DESCRIPTION OF THE DRAWINGS

The above and other features and advantages of the present invention will become more apparent by describing in detail exemplary embodiments thereof with reference to the attached drawings in which:

FIG. 1 shows a structure of a conventional plasma display panel with a 3-electrode surface discharge structure;

FIG. 2 is a block diagram of a conventional driving apparatus for driving the conventional plasma display panel of FIG. 1;

FIG. 3 is a view for explaining a conventional address-display separation driving method applied to Y electrode lines of the conventional plasma display panel of FIG. 1;

FIG. 4 is a timing diagram of an example of driving signals used in the conventional plasma display panel of FIG. 1;

FIG. 5 is a view for explaining a display panel driving method which groups scanning electrodes into a plurality of groups and divides a frame into a plurality of sub-fields for each group;

FIG. 6 is a timing diagram showing sustain periods for explaining a display panel driving method according to an exemplary embodiment of the present invention;

FIG. 7 is a conceptual scheme for explaining a display panel driving method based on an address/sustain discharge mixed method, according to an exemplary embodiment of the present invention;

FIGS. 8A, 9B, 9C and 9D are views for explaining a display panel driving method which groups scanning electrodes into four groups on the basis of the display panel driving method of FIG. 7, according to an exemplary embodiment of the present invention;

FIG. 9A is a timing diagram of sub-field driving signals when the driving method of FIG. 8A is applied to two scanning electrode groups, according to an exemplary embodiment of the present invention;

FIG. 9B is a timing diagram of sub-field driving signals when the driving method of FIG. 8A is applied to two scanning electrode groups, according to an exemplary embodiment of the present invention;

FIG. 10 is a circuit diagram showing an exemplary Y driver circuit for generating panel driving signals shown in FIGS. 9A and 9B; and

FIG. 11 is a circuit diagram showing another exemplary Y driver circuit for generating the panel driving signals shown in FIGS. 9A and 9B.

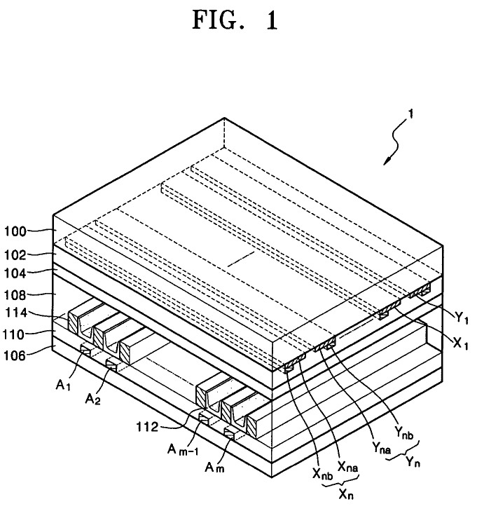

### DETAILED DESCRIPTION OF THE INVENTION

Hereinafter, embodiments of the present invention will be described in detail with reference to the appended drawings. The embodiments of the present invention will be described on the basis of a method for driving an AC type plasma display panel. However, it is understood that various modifications may be made without departing from the scope of the present invention, including the type of plasma display panel used therewith.

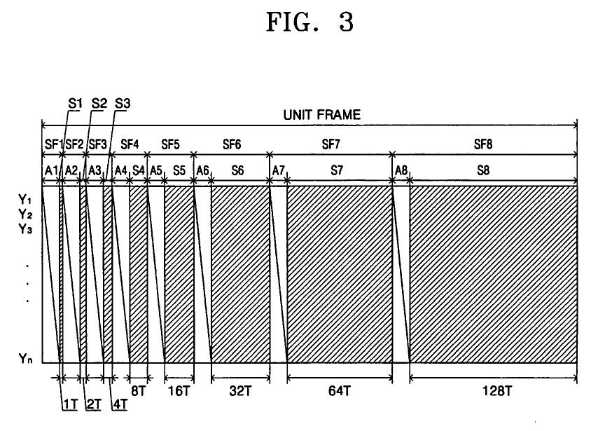

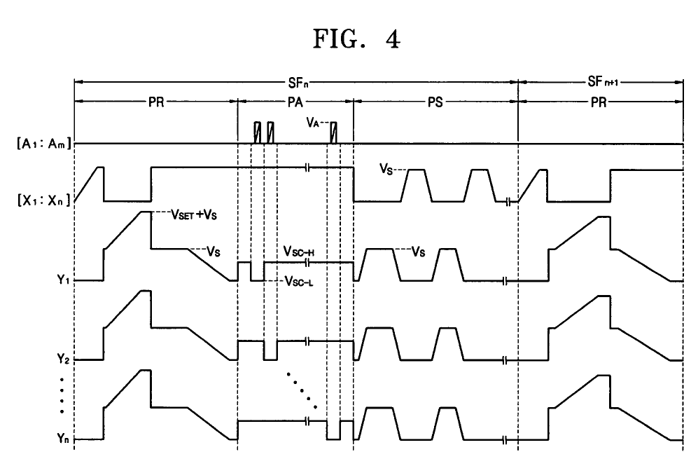

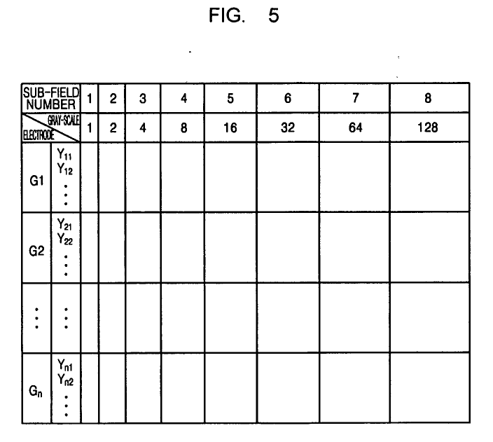

FIG. 5 is a view for explaining a display panel driving method, which groups scanning electrodes into a plurality of groups (n groups) and divides a frame into a plurality of sub-fields for each group to thereby drive each of the groups individually. In FIG. 5, each the group represents a gray-scale value by a combination of 8 sub-fields, as described with reference to FIG. 3.

When scanning electrodes are grouped into a plurality of groups, the scanning electrodes can be divided into a predetermined number of groups according to their physical locations. For example, in a case where a panel consists of 800 scanning lines, it is possible to divide the 800 scanning lines into 8 groups, set 1-th through 100-th scanning lines to a first group, and set 101-th through 200-th scanning lines to a second group. Also, when grouping the scanning lines, it is possible to group scanning lines spaced by a predetermined interval into a group, as well as to group neighboring scanning lines into a group. For example, 1-th, 9-th, 17-th, . . . , (8k+1)-th scanning lines can be allocated to a first group, and 2-th, 10-th, 18-th, . . . , (8k+2)-th scanning lines can be allocated to a second group. It is also possible to group the scanning lines in an irregular manner as necessary.

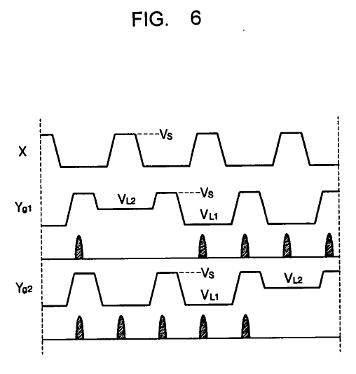

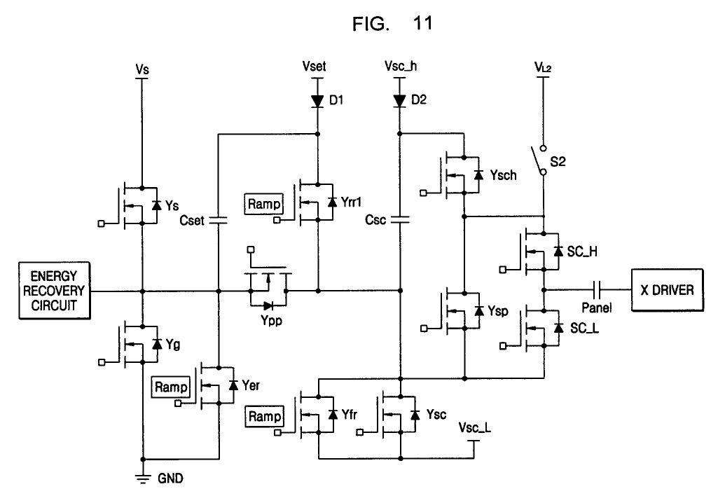

FIG. 6 is a timing diagram showing sustain periods PS for explaining a display panel driving method according to an exemplary embodiment of the present invention. In the embodiment shown in FIG. 11, cells of a display panel are divided into two scanning electrode groups Y_{g1} and Y_{g2}.

In an address period, a sustain discharge of selected display cells is carried out by applying a high level and a low level of a sustain discharge signal alternately to scanning electrodes and a common electrode. At this time, if a potential difference formed between the scanning electrodes and the common electrode is greater than a break-down voltage, a discharge is carried out. Otherwise, no discharge is carried out.

Referring to FIG. 6, a sustain discharge signal of a common electrode X has a high level V_{S} and a low level V_{L1}. Also, a sustain discharge signal of each of the scanning electrodes Y_{g1} and Y_{g2} has a high level V_{S}, a first low level V_{L1} and a second low level V_{L2}.

In the drawing, a voltage higher than the break-down voltage is formed between the scanning electrodes Y_{g1} and Y_{g2} and the common electrode X, by a potential difference between the high level V_{S} of the scanning electrodes Y_{g1} and Y_{g2} and the low level V_{L1} of the common electrode X. Also, a voltage higher than the break-down voltage is formed between the common electrode X and the scanning electrodes Y_{g1} and Y_{g2} by a potential difference between the high level V_{S} of the common electrode X and the first low level V_{L1} of the scanning electrodes Y_{g1} and Y_{g2}. Also, a voltage lower than the break-down voltage is formed between the common electrode X and the scanning electrodes Y_{g1} and Y_{g2} by a potential difference between the high level V_{S} of the common electrode X and the second low level V_{L2} of the scanning electrodes Y_{g1} and Y_{g2}.

Considering the first scanning electrode group Y_{g1}, a sustain discharge signal is applied in an order of V_{L1}->V_{S}->V_{L2}->V_{S}->V_{L1}->V_{S}->V_{L1}->V_{S}. In a display cell addressed in an address period PA, no discharge is carried out in the following sustain discharge period PS if the corresponding first scanning electrode group Y_{g1} is in the first low level V_{L1} and the corresponding common electrode X is in a high level. When the first scanning electrode group Y_{g1} is changed to the high level V_{S} and the common electrode X is changed to the low level V_{L2}, a discharge is carried out in the corresponding display cell. Then, if the first scanning electrode group Y_{g1} is changed to the second low level V_{L2} and the common electrode X is changed to the high level V_{S}, no discharge is carried out. Accordingly, thereafter, although the first scanning electrode group Y_{g1} is changed to the high level V_{S} and the common electrode X is changed to the low level V_{L2}, no discharge is carried out. As a result, two alternate discharge points are skipped. Then, when the first scanning electrode group Y_{g1} is changed to the first low level V_{L1} and the common electrode X is changed to the high level V_{S}, a discharge is carried out. As a result, during the sustain period shown in FIG. 6, discharges are carried out five times between the common electrode X and the first scanning electrode group Y_{g1}.

Considering the second scanning electrode group Y_{g2}, a sustain discharge signal is applied in an order of V_{L1}->V_{S}->V_{L1}->V_{S}->V_{L1}->V_{S}->V_{L2}->V_{S}. In a display cell addressed in an address period PA, no discharge is carried out in the following sustain period PS if the corresponding second scanning electrode group Y_{g2} is in the first low level V_{L1} and the corresponding common electrode X is in a high level. A discharge is carried out in the corresponding display cell, when the second scanning electrode group Y_{g2} is changed to the high level V_{S} and the common electrode X is changed to the low level V_{L1}. If the second scanning electrode group Y_{g2} is changed to the first low level V_{L1} and the common electrode X is changed to the high level V_{S}, a discharge is carried out. As such, the high level V_{S} and the first low level V_{L1} are applied alternately to the second scanning electrode group Y_{g2} and the common electrode X, so that discharges are carried out five times. Thereafter, although the second scanning electrode group Y_{g2} is changed to the high level V_{S} and the common electrode X is changed to the low level V_{L1}, no discharge is carried out. As a result, during the sustain period shown in FIG. 6, discharges are carried out five times between the common electrode X and the second scanning electrode group Y_{g2}.

As described above, by applying the first low levels V_{L1} and the second low levels V_{L2} of the sustain discharge signal to the scanning electrode groups in a different order, it is possible to control sustain discharges of the scanning electrode groups differently.

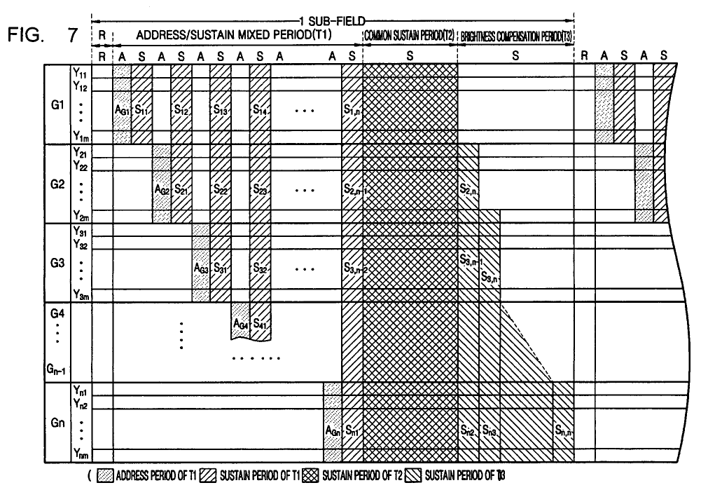

FIG. 7 is a conceptual scheme for explaining a display panel driving method based on an address/sustain discharge mixed method, according to an exemplary embodiment of the present invention. The present embodiment is aimed to achieve a stable sustain discharge by minimizing a temporal gap between an address period and a sustain period in implementing gray-scale, as will be described in detail as follows.

Scanning electrodes of a panel are grouped into a plurality of groups G1 through Gn and are addressed sequentially for each group. After addressing of a scanning electrode group is complete, a sustain discharge pulse is applied to the scanning electrode group, thereby applying a sustain period to the corresponding electrode group. At this time, the sustain period can be applied selectively to different scanning electrode groups having been addressed. As such, after an address period and a following sustain period are applied to a scanning electrode group, the address period can be applied to different scanning electrode groups not having been addressed. Here, when the scanning electrodes constructing the panel are divided into the plurality of groups, the numbers of the scanning electrodes belonging to each of the groups can be the same in all the groups or can be different for each of the groups.

Referring to FIG. 7, a sub-field includes a reset period R, an address/sustain mixed period T1, a common sustain period T2 and a brightness compensation period T3. In the drawing, dotted blocks represent address periods in the address/sustain mixed period T1, left oblique lined blocks represent sustain periods in the address/sustain mixed period T1, a checked block represents a sustain period in the common sustain period T2, and right oblique lined blocks represent sustain periods in the brightness compensation period T3.

Here, the common sustain period T2 and the brightness compensation period T3 may be omitted according to a gray-scale value allocated to a corresponding sub-field. A sub-field with a relatively low gray-scale requires a relatively short sustain discharge period for implementing the gray-scale. Correspondingly, a sub-field with a relatively high gray-scale requires a relatively long sustain discharge period. Accordingly, a sub-field with a relatively low gray-scale may have only a single address/sustain mixed period T1. A sub-field with a relatively high gray-scale may have an address/sustain mixed period T1, a common sustain period T2 and a brightness compensation period T3. Meanwhile, a sub-field with a middle level of gray-scale can have an address/sustain mixed period T1 and a brightness compensation period T3 without a common sustain period T2.

During the reset period R, reset pulses are applied to all the scanning line groups to initialize states of wall charges of cells. During the address/sustain mixed period T1, scanning pulses are applied sequentially from a first scanning electrode line Y₁₁ to a final scanning electrode line Y₁ₘ in a first group G1, so that an address period AG1 is applied to the first group G1. After all the cells of the first group G1 are addressed, a sustain discharge period S11 is applied to these addressed cells in order to sustain-discharge the cells using a predetermined number of sustain pulses. When a first sustain period S11 for the first group G1 ends, an address period AG2 is applied to cells belonging to a second group G2.

When the address period AG2 for the second group G2 ends, that is, when addressing of scanning electrodes belonging to the second group G2 is complete, a first sustain period S21 is applied to the second group G2. At this time, a second sustain period S12 is also applied to the first group G2 having been addressed. However, if desired gray-scale is obtained in the first sustain period S11 of the first group G1, the second sustain period S12 of the first group G1 can be omitted. Here, cells still not entering the address period are maintained in a pause state.

When the first sustain period S21 for the second group G2 ends, an address period SG3 and a first sustain period S31 are applied to a third group G3 in the same manner as described above. During the first sustain period S31 for the third group G3, the sustain periods S13 and S22 can be applied to the cells of the first and second groups G1 and G2 having been addressed. If the desired gray-scale is obtained during the first sustain discharge periods S13 and S22 of the first and second groups, the additional sustain discharge periods S13 and S22 can be omitted.

The scanning pulses are applied sequentially to the scanning electrodes belonging to the final group Gn in the same manner as described above, so that an address period AGn is applied to the final group Gn. Successively, a sustain period Sn1 is applied to the final group Gn. During the sustain period Sn1 for the final group Gn, the sustain period Sn1 is also applied to cells of different groups.

FIG. 7 shows an example where the sustain period is applied to cells of different groups having been addressed while a sustain period is applied to cells of a certain group. If the number of the sustain pulses applied during a unit sustain period is constant and accordingly brightness created by the sustain pulses is constant, the brightness of the cells of the first group will be n times of that of the cells of the n-th group. Likewise, the brightness of the cells of the second group will be n−1 times of that of the cells of the n-th group. Also, the brightness of the cells of the (Gn−1)-th group will be two times that of the cells of the n-th group. In order to compensate for such brightness differences for each of the groups, a predetermined additional sustain period is needed. Such an additional sustain period is the brightness compensation period T3 shown in FIG. 7.

The brightness compensation period T3 is applied selectively to each of the groups so that gray-scales of the cells of each of the groups become uniform. The common sustain period T2 is a period for applying sustain pulses to all the cells at the same time during a predetermined time. The common sustain period T2 can be applied selectively in the case where gray-scales allocated to each of sub-fields are not obtained in the address/sustain mixed period T1 or in the common sustain period T2 and the brightness compensation period T3. The common sustain period T2 can follow the address/sustain mixed period T1 as shown in FIG. 12, or can follow the brightness compensation period T3.

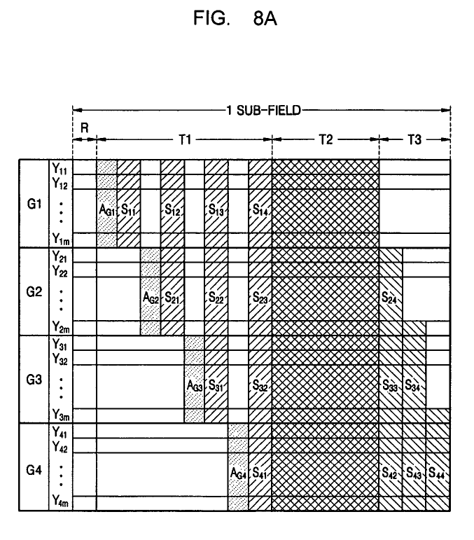

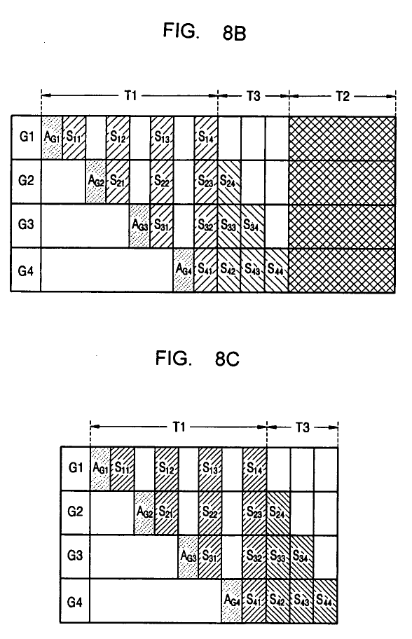

FIG. 8A is a view for explaining a display panel driving method which drives a display panel including pixels divided into four groups on the basis of the display panel driving method of FIG. 7, according to an exemplary embodiment of the present invention. Referring to FIG. 8A, a sub-field has a reset period R, an address/sustain mixed period T1, a common sustain period T2, and a brightness compensation period T3. Detailed descriptions for the sub-field have been provided above with reference to FIG. 7.

FIG. 8B shows an example in which the brightness compensation period T3 is used prior to the common sustain period T2, as a modified example of FIG. 8A. The embodiments shown in FIGS. 8A and 8B may be useful in implementing sub-fields with a high weight. Also, the length of the common sustain period T2 may be changed appropriately according to the weight of a corresponding sub-field.

FIG. 8C shows an example in which a sub-field has only an address/sustain mixed period T1 and a brightness compensation period T3 without a common sustain period T2, as a modified example of FIG. 8A. In the present embodiment, supplying sustain pulses is terminated to at least a group during the address/sustain mixed period T1. That is, in FIG. 8C, a sustain discharge for the first group G1 is complete in the address/sustain mixed period T1. The embodiment of FIG. 8C may be useful in implementing a sub-field with a middle level of weight.

FIG. 8D shows an example in which a sub-field has only an address/sustain mixed period T1, as another modified example of FIG. 8A. After an address operation and a sustain discharge operation for a group are terminated, an address operation and a sustain discharge operation for a different group are performed sequentially. Therefore, the address/sustain mixed period T1 is applied sequentially to the first through final groups. The embodiment of FIG. 8D may be useful in implementing a sub-field with a low weight.

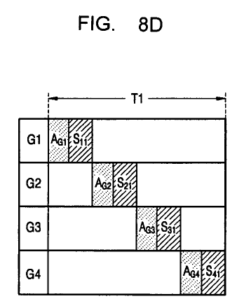

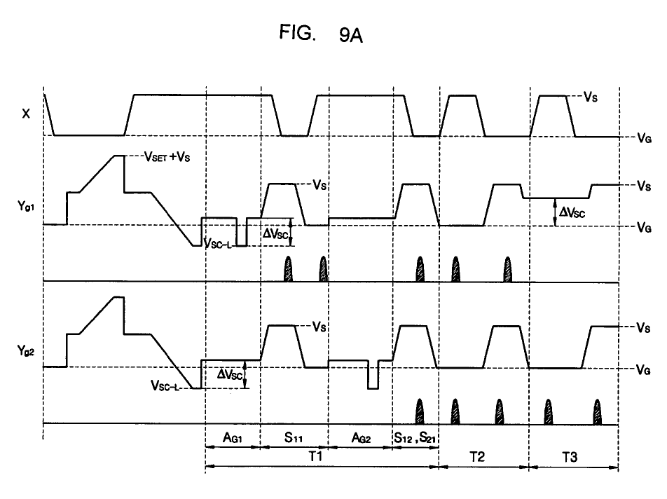

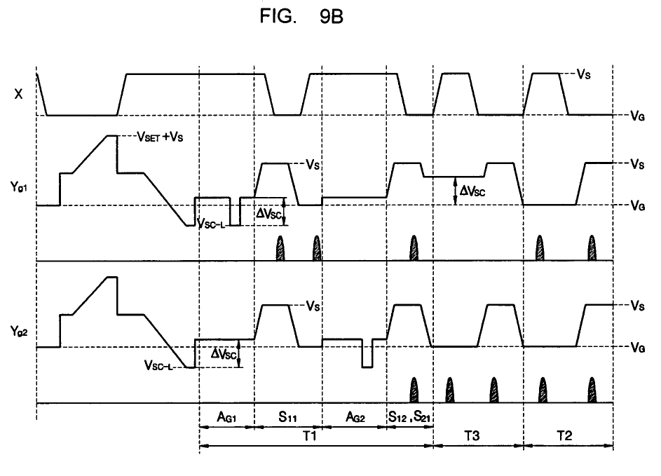

FIG. 9A is a timing diagram of sub-field driving signals when the driving method of FIG. 8A is applied to two scanning electrode groups Y_{g1} and Y_{g2}, according to an embodiment of the present invention. After a reset period R, a sub-field includes an address/sustain mixed period T1, a common sustain period T2, and a brightness compensation period T3, in this order. During the reset period R, reset pulses are applied to all scanning electrode line groups so to initialize the states of wall charges of cells.

During the address/sustain mixed period T1, a first address period AG1 of the first scanning electrode group Y_{g1} is performed and a sustain period S11 of the second scanning electrode group Y_{g2} is performed. An address period AG2 of the second scanning electrode group A_{g2} is performed after the sustain period S11 of the first scanning electrode group Y_{g1} terminates. Then, a second sustain period S12 of the first scanning electrode group Y_{g1} is performed and, simultaneously, a first sustain period S21 of the second scanning electrode group Y_{g2} is performed.

After the address/sustain mixed period T1, a common sustain period T2 starts. In the common sustain period T2, a discharge is carried out in all the first and second scanning electrode groups Y_{g1} and Y_{g2}. After the common sustain period T3, the brightness compensation period T3 starts. In the brightness compensation period T3, a discharge is carried out only between the second scanning electrode group Y_{g2} and the common electrode X. Comparing the potential levels of the sustain discharge signal shown in FIGS. 9A and 9B with those of the sustain discharge signal shown in FIG. 6, the high levels of both the sustain discharge signals are the same as V_{S} \. However, the first low level of the sustain discharge signal of FIG. 11 is V_{L1} and the first low level of the sustain discharge signal of FIG. 9A is V_{G}. Also, the second low level of the sustain discharge signal of FIG. 6 is V_{L2} and the second low level of the sustain discharge signal of FIG. 9A is ΔV_{SC}. The second low level of the sustain discharge signal of FIG. 6 is V_{L2} and the second low level of the sustain discharge signal of FIG. 9B is ΔV_{SC}. At this time, if a potential difference formed between the scanning electrode and the common electrode is greater than a discharge start voltage, a discharge is carried out. Otherwise, no discharge is carried out.

Referring to FIG. 9A, the sustain discharge signal of the common electrode has a high level V_{S} and a first low level V_{G}. Also, each of the sustain discharge signals of the scanning electrode groups Y_{g1} and Y_{g2} has a high level V_{S}, a first low level V_{G} and a second low level ΔV_{SC}.

In the drawing, due to a potential difference between the high level V_{S} of the scanning electrode groups Y_{g1} and Y_{g2} and the first low level V_{G} of the common electrode X, a voltage higher than the discharge start voltage is formed between the scanning electrode groups Y_{g1} and Y_{g2} and the common electrode X. Also, due to a potential difference between the high level V_{S} of the common electrode X and the second low level ΔV_{SC} of the scanning electrode groups Y_{g1} and Y_{g2}, a voltage lower than the discharge start voltage is formed between the common electrode X and the scanning electrode groups Y_{g1} and Y_{g2}.

Referring to FIG. 9A, in cells selected during the address period AG1 of the first group Y_{g1}, in the period S11, the V_{S} and V_{G} are applied alternately between the first scanning electrode group Y_{g1} and the common electrode X, so that discharges are carried out twice.

Then, in cells selected during the address period AG2 of the second group Y_{g2}, in the period S12, the V_{S} and V_{G} are applied respectively to the second scanning electrode group Y_{g2} and the common electrode X, so that a discharge is carried out one time. At this time, the V_{S} and V_{G} are also applied respectively to the first scanning electrode group Y_{g1} and the common electrode X, so that a discharge is carried out one time in the cells selected during the address period AG1 of the first group Y_{g1}.

Then, in the common sustain period T2, the V_{G} and V_{S} are applied alternately to the scanning electrode groups Y_{g1} and Y_{g2} and the common electrode X, so that discharges are carried out twice in the first and second groups Y_{g1} and Y_{g2}. Then, in the brightness compensation period T3, ΔV_{SC} and V_{S} are applied sequentially to the first scanning electrode group Y_{g1}, and the V_{G} and V_{S} are applied sequentially to the second scanning electrode group Y_{g2}. Accordingly, in the brightness compensation period T3, no discharge is carried out in the cells of the first group Y_{g1} and discharges are carried out twice in the cells of the second group Y_{g2}. As a result, in the sub-field shown in FIG. 9A, each of the first and second groups Y_{g1} and Y_{g2} is discharged five times

FIG. 9B is a timing diagram of sub-field driving signals when the driving method of FIG. 8B is applied to the two scanning electrode groups Y_{g1} and Y_{g2}, according to an embodiment of the present invention.

A difference between FIG. 9B and FIG. 9A is that the common sustain period T2 and the brightness compensation period T3 are reversed when compared to each other. In the brightness compensation period T3 after the address/discharge mixed period T1, ΔV_{SC} and V_{S} are applied sequentially to the first scanning electrode groups Y_{g1}, and V_{G} and V_{S} are applied sequentially to the second scanning electrode group Y_{g2}. Accordingly, in the brightness compensation period T3, no discharge is carried out in the cells of the first group Y_{g1} and discharges are carried out two times only in the cells of the second group Y_{g2}. As a result, in the sub-field shown in FIG. 9B, each of the first and second groups Y_{g1} and Y_{g2} is discharged five times.

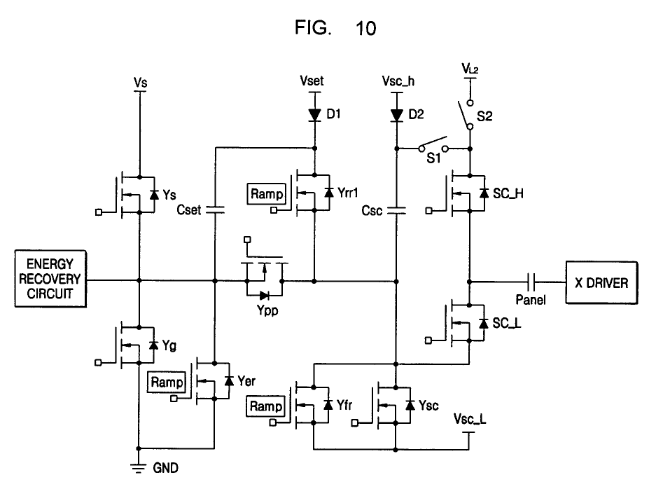

FIG. 10 is a circuit diagram of an exemplary Y driver circuit for generating the panel driving signals shown in FIGS. 9A and 9B. An energy recovery circuit connected to a node located between switches Ys and Yg includes a capacitor for energy accumulation and an inductor, wherein the energy recovery circuit enhances the power efficiency using a LC resonance due to a panel capacitance of the capacitor and an inductance of the inductor. An example of such an energy recovery circuit is disclosed in U.S. Pat. No. 4,866,349 and No. 5,670,974. In a reset period, a rising ramp interval V_{S} through V_{S}+Vₛₑₜ is applied to the panel via a path passing through the switch Ys, a capacitor Cset and switches Yrr1 and SC_L. Also, in the reset period PR, a falling ramp interval V_{S} through V_{SC—L} is applied to the panel via a path passing through switches Yfr and SC_L in the state that the switches Ys and Ypp are turned on.

In FIG. 10, as viewed with respect to a first node located between a scanning capacitor Csc and a switch Ysc, a left portion is a sustain driving part, a upper portion is a scanning signal high level applying part, and a lower portion is a scanning signal low level applying part.

The sustain driving part includes a switch Ys connected to a high level source V_{S} for providing a high level of a sustain signal, and a switch Yg connected to a first low level source GND for providing a low level of the sustain signal. The sustain driving part can further include a voltage source Vset and switches Yrr1 and Ypp in order to provide a ramp reset signal in the reset period.

The scanning signal high level applying part includes a scanning capacitor Csc and a high level scanning source V_{SC—H}. The scanning signal high level applying part is connected to a scanning electrode line of a panel through a high level scanning switch SC_H.

The scanning signal low level applying part includes a switch Ysc and a low level scanning source V_{SC—L}. The scanning signal low level applying part is connected to the scanning electrode line of the panel through the low level scanning switch SC_L.

A first switch S1 is connected to a node located between the high level scanning source V_{SC—H} and the scanning capacitor Csc. A second low level applying part V_{L2} is connected through a second switch S2 to a node located between the first switch S1 and the high level scanning switch SC_H.

The first switch S1 and the second switch S2 are turned on so as to be toggled to each other. The first switch S1 and the second switch S2 control a second low level of a sustain discharge signal supplied to the panel in the brightness compensation period T3. Here, the V_{SC—H} is a different voltage source from the V_{L2}. During the address periods AG1 and AG2 of FIG. 14A, the first switch S1 is turned on and the second switch S2 is turned off.

In FIG. 9A, during the brightness compensation period T3, ΔV_{SC} as a second low level of a sustain discharge signal is applied. For that, in FIG. 10, the first switch S1 is turned on and the second switch S2 is turned off. If V_{L2}, instead of ΔV_{SC}, as the second low level of the sustain discharge signal, should be applied during the brightness compensation period T3 of FIG. 14A, the first switch S1 is turned off and the second switch S2 is turned on.

Referring to FIGS. 10 and 9A, in the reset period PR, a rising ramp period of V_{S} through V_{S}+Vₛₑₜ is applied to the panel via a path passing through a switch Ys, a capacitor Cset and switches Yrr1 and SC_L. Also, in the reset period PR, a falling ramp period of V_{S} through V_{SC—L} is applied to the panel via a path passing through a switch Yfr and the switch SC_L in the state that the switches Ys and Ypp are turned on. A final potential of the reset period PR is a scanning potential V_{SC-L} with a low level.

In the address/sustain mixed period T1, first, an address period AG1 of the first group Y_{g1} appears. During the address period AG1, the first switch S1 is turned on and the second switch S2 is turned off. At this time, if the high level scanning switch SC_H is turned on and the low level scanning switch SC_L is turned off, a high level scanning voltage V_{SC—L}+ΔV_{SC} is applied to the panel. If the high level scanning switch SC_H is turned off and the low level scanning switch SC_L is turned on, a low level scanning voltage V_{SC-L} is applied to the panel. Here, the ΔV_{SC} is a voltage applied to the scanning capacitor Csc, as a voltage difference between the high level scanning source V_{SC—H} and the low level scanning source V_{SC—L}.

In the sustain period S11 of the first group Y_{g1}, the switches Ys and Yg are turned on alternately, so that a sustain pulse is applied to the panel through the switches Ypp and SC_L. At this time, as not shown in detail in the drawing, a switch for applying the V_{S} and a switch for applying the V_{G} are turned on alternately in the X driver so that a X driving signal is generated in the period S11. Therefore, in the sustain period S11 of the first group Y_{g1}, discharges are carried out two times in the cells selected in the address period AG1 of the first group Y_{g1}.

The address period AG2 of the second group Y_{g2} is performed by the same switching mechanism as in the address period AG1 of the first group Y_{g1}, in the circuit of FIG. 15. Then, a sustain discharge is carried out in the second sustain period S12 of the first group Y_{g1}, the first sustain period S21 of the second group Y_{g2}, and the common sustain period T2, by the same switching mechanism as in the first sustain period S11 of the first group Y_{g1}.

Then, a brightness compensation period T3 starts. During the brightness compensation period T3, the first switch S1 is turned off and the second switch S2 is turned on.

Returning to FIG. 9A, during the brightness compensation period T3, ΔV_{SC} is applied as a second low level of the sustain discharge signal. At this time, in the Y driver circuit of FIG. 10, the first switch S1 is turned on and the second switch S2 is maintained in a turned-off state. In order to apply a high level V_{S} of the sustain discharge signal to the panel in the brightness compensation period T3, the switches Ys, Ypp and SC_L are turned on. In order to apply the first low level V_{G} of the sustain discharge signal to the panel in the brightness compensation period T3, the switches Yg, Ypp and SC_L are turned on. In order to apply the second low level ΔV_{SC} of the sustain discharge signal to the panel in the brightness compensation period T3, the switches Yg, Ypp and SC_H are turned on.

Also, in order to apply V_{L2}, instead of the ΔV_{SC}, as the second low level of the sustain discharge signal to the panel in the brightness compensation period T3 of FIG. 9A, the first switch S1 is turned off, the second switch S2 is turned on and the switch SC_H is turned on.

FIG. 11 is a circuit diagram of another exemplary Y driver circuit for generating the panel driving signals shown in FIGS. 9A and 9B. FIG. 11 shows a circuit where switches Ysch and Ysp are added to the circuit of FIG. 10. Here, the switch Ysch operates in the same manner as the first switch S1 of FIG. 10, in the brightness compensation period T3. A switching operation for implementing the reset period PR is the same as described above with reference to FIG. 10.

When the address period AG1 starts, the second switch S2 is turned off. At this time, if the switches Ysch and SC_H are turned on and the low level scanning switch SC_L is turned off, a scanning voltage V_{SC—L}+ΔV_{SC} with a high level is applied to the panel. If the high level scanning switch SC_H is turned off and the low level scanning switch SC_L is turned on, the low level scanning voltage V_{SC—L} is applied to the panel. Here, the ΔV_{SC} is a voltage applied to the scanning capacitor Csc, as a voltage difference between the high level voltage source V_{SC—H} and the low level voltage source V_{SC—L}.

In the sustain periods S11 and S12 of the first group Y_{g1}, the sustain period S21 of the second group Y_{g1}, and the common sustain period T2, the switches Ys and Yg are turned on alternately, so that sustain pulses are applied to the panel via the switches Ypp and SC_L. At this time, as not shown in the drawing, a switch for applying the V_{S} and a switch for applying the V_{G} are turned on alternately in the X driver, so that a X driving signal is generated in the sustain period S11.

Referring to FIG. 9A, the ΔV_{SC}, as the second low level of the sustain discharge signal, is applied in the brightness compensation period T3. At this time, in the circuit of FIG. 11, the switch Ysch is turned on and the second switch S2 is maintained in a turned-off state. In order to apply the high level V_{S} of the sustain discharge signal to the panel in the brightness compensation period T3, the switches Ys, Ypp and SC_L are turned on. In order to apply the first low level V_{G} of the sustain discharge signal to the panel in the brightness compensation period T3, the switches Yg, Ypp and SC_L are turned on. In order to apply the second low level ΔV_{SC} of the sustain discharge signal to the panel in the brightness compensation period T3, the Yg switch, the switches Ypp, Ysch and SC_H are turned on.

In order to apply V_{L2}, instead of ΔV_{SC}, as the second low level of the sustain discharge signal to the panel in the brightness compensation period T3 of FIG. 9A, the switch Ysch is turned off, the second switch S2 is turned on and the switch SC_H is turned on.

Where the ΔV_{SC} is applied as the second low level of the sustain discharge signal in the brightness compensation period T3, it will be appreciated that the first switch S1 and the second switch S2 may be omitted in the circuits of FIGS. 10 and 11. That is, it will be appreciated that the panel driving method according to the present invention may also be implemented using other conventional circuits, if the ΔV_{SC} as the second low level of the sustain discharge signal is applied to the panel in the brightness compensation period T3.

The display panel driving method according to the present invention may be used by a display apparatus which sequentially provides an address period for selecting cells to be turned on and a sustain period for lighting the selected cells. For example, it will be understood that the present invention can be applied to an image display device which sequentially provides an address period and a sustain period using space charges, such as an AC type PDP, a DC type PDP, an EL display device, or a liquid display device.

The present invention may be embodied as a program stored on a computer readable medium that can be run on a general computer. Here, the computer readable medium includes but is not limited to storage media such as magnetic storage media (e.g., ROM's, floppy disks, hard disks, etc.), optically readable media (e.g., CD-ROMs, DVDs, etc.). Here, a program stored in the readable medium may be a series of instruction commands that are used directly or indirectly in a medium with information processing capability, such as a computer. Accordingly, the term “computer” should be interpreted to include all mediums with information processing capability, which include, but are not limited to, a memory, an input/output device, and an operation device and perform particular functions using a program.

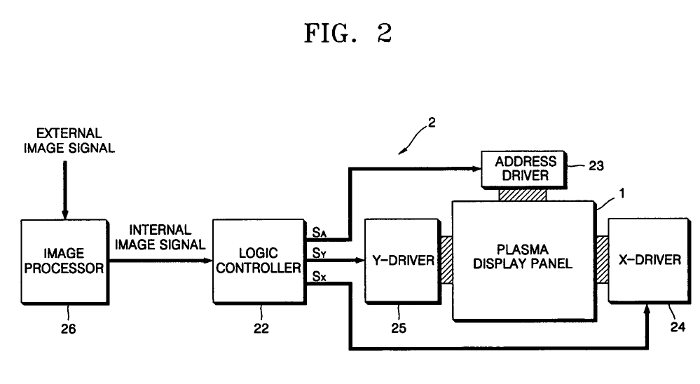

As described above, the logic controller 202 and the image processor 200 included in the panel driving apparatus shown in FIG. 2 are constructed into an integrated circuit including a memory and a processor therein. The memory may store a program for a method for driving the panel. When the display panel is driven, the program stored in the memory is executed, so that the addressing and sustain operations according to the present invention can be performed. Alternately, the program for executing such a panel driving method therein can be stored on a recording medium.

In particular, the program for executing the panel driving method may be written in schematic or VHDL (Very high speed integrated circuit Hardware Description Language) and be executed by a programmable integrated circuit, for example, FPGA (Field Programmable Gate Array). The recording medium includes the programmable integrated circuit.

As described above, according to the present invention, the following effects may be obtained.

It is possible to group display cells into a plurality of groups and drive each group individually without an additional driving circuit.

In addition, it is possible to stably generate a sustain discharge, by grouping display cells into a plurality of groups without an additional driving circuit and minimizing a temporal gap between an addressing period and a sustain period in implementing gray-scale according to a frame to subfields conversion method.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A display panel driving method comprising the steps of:
grouping display cells included in scanning electrodes and common electrodes into a plurality of groups;
dividing and driving a frame into a plurality of sub-fields for each group, wherein, each of the plurality of sub-fields includes an address period and a sustain period;
in the address period, selecting cells to be displayed; and
in the sustain period, applying high levels and low levels of a sustain discharge signal alternately to the scanning electrodes and the common electrodes so to perform a sustain discharge;
wherein in at least one sustain period, the high level potentials of the sustain discharge signal applied to the scanning electrode are the same in all the groups and the high level potentials of the sustain discharge signal are applied at the same time to all the groups; and
low level potentials of the sustain discharge signal applied to the scanning electrodes include a first low level potential and a second low level potential higher than the first low level potential.

2. The method of claim 1, wherein the first low level and the second low level potentials are applied to each of the groups at different times.

3. The method of claim 1, wherein a discharge is carried out during an overlapping period of the first low level of the scanning electrode and a high level of the common electrode.

4. The method of claim 1, wherein no discharge is carried out during an overlapping period of the second low level potential of the scanning electrode and the high level potential of the common electrode.

5. The method of claim 1, wherein the second low level potential is equal to a potential difference between a high level potential and a low level potential of the scanning pulse applied to the scanning electrodes in the address period.

6. A display panel driving method comprising the steps of:
grouping display cells included in scanning electrodes and common electrodes into a plurality of groups;
dividing a frame into a plurality of sub-fields for each group, wherein,
each of the plurality of sub-fields includes an address period and a sustain period; and
in at least one of the plurality of sub-fields, sequentially performing the address period and the sustain period to each group in a manner that:
a) addressing of each group is performed and then the sustain period is performed in cells of each group subjected to addressing;
b) the addressing of cells of an unaddressed group is performed after the sustain period ends for a previous group; and
c) the sustain period is performed selectively in the cells of the unaddressed group subjected to addressing while the sustain period is performed in cells of that group,
wherein in at least one sustain period, high level potentials of the sustain discharge signal applied to the scanning electrode are the same in all the groups and the high level potentials of the sustain discharge signal are applied at the same time to all the groups; and
low level potentials of the sustain discharge signal are applied to the scanning electrodes include a first low level potential and a second low level potential, where the second low level potential is higher than the first low level potential.

7. The method of claim 6, wherein the first low level and the second low level potentials are applied to each of the groups in different timings.

8. The method of claim 6, wherein a discharge is carried out during an overlapping period of the first low level potential of the scanning electrode and a high level potential of the common electrode.

9. The method of claim 6, wherein no discharge is carried out during an overlapping period of the second low level potential of the scanning electrode and the high level potential of the common electrode.

10. The method of claim 6, wherein the second low level potential is equal to a potential difference between a high level potential and a low level potential of the scanning pulse applied to the scanning electrodes in the address period.

11. The method of claim 6, wherein the sustain period further includes a common period for performing sustain discharges at the same time in all groups during a predetermined time.

12. The method of claim 6, wherein the sustain period further includes a compensation period for performing an additional sustain discharge selectively for each of the groups so that each of the groups satisfies a predetermined gray-scale.

13. A display panel driving apparatus which applies a scanning signal and a sustain discharge signal to a scanning electrode line of a display panel, the apparatus comprising:
a first node;
a sustain driving unit connected to the first node;
a scanning signal high level applying unit connected to the first node;
a scanning signal low level applying unit connected to the first node;
a first switch, having one end connected to the scanning signal high level applying unit;
a second low level applying unit, which applies a second low level of a sustain discharge signal;
a second switch connected between another end of the first switch and the second low level applying unit;
a high level scanning switch connected between the other end of the first switch and the scanning electrode line; and
a low level scanning switch connected between the scanning electrode line and the scanning signal low level applying unit.

14. The apparatus of claim 13, wherein the first switch and the second switch are toggled to each other.

15. The apparatus of claim 13, wherein the sustain driving unit comprises:
a high level power source for providing a high level of the sustain discharge signal;
a high level switch connected between the high level source and the first node;
a first low level power source for providing a first low level of the sustain discharge signal; and
a low level switch connected between the first low level source of the sustain discharge signal and the first node.

16. The apparatus of claim 13, wherein the scanning signal high level applying unit comprises:
a high level scanning power source; and
a scanning capacitor connected between the first node and the high level scanning source,
wherein the first switch is connected to a node located between the high level scanning source and the scanning capacitor.

17. The apparatus of claim 13, wherein the scanning signal low level applying unit comprises,
a low level scanning source; and
a control switch connected between the first node and the low level scanning source.

18. A computer-readable medium having embodied thereon a computer program for executing a display panel driving method, the medium comprising:
code for grouping display cells included in scanning electrodes and common electrodes into a plurality of groups;
code for dividing and driving a frame into a plurality of sub-fields for each group, wherein, each of the plurality of sub-fields includes an address period and a sustain period;
code for, in the address period, selecting cells to be displayed; and
code for, in the sustain period, applying high levels and low levels of a sustain discharge signal alternately to the scanning electrodes and the common electrodes so to perform a sustain discharge;
wherein in at least one sustain period, the high level potentials of the sustain discharge signal applied to the scanning electrode are the same in all the groups and the high level potentials of the sustain discharge signal are applied at the same time to all the groups; and
low level potentials of the sustain discharge signal applied to the scanning electrodes include a first low level potential and a second low level potential higher than the first low level potential.

19. The medium of claim 18, wherein the first low level and the second low level potentials are applied to each of the groups at different times.

20. The medium of claim 18, wherein a discharge is carried out during an overlapping period of the first low level of the scanning electrode and a high level of the common electrode.

21. The medium of claim 18, wherein no discharge is carried out during an overlapping period of the second low level potential of the scanning electrode and the high level potential of the common electrode.

22. The medium of claim 18, wherein the second low level potential is equal to a potential difference between a high level potential and a low level potential of the scanning pulse applied to the scanning electrodes in the address period.

23. A computer-readable medium having embodied thereon a computer program for executing a display panel driving method, the medium comprising:
code for grouping display cells included in scanning electrodes and common electrodes into a plurality of groups;
code for dividing a frame into a plurality of sub-fields for each group, wherein,
each of the plurality of sub-fields includes an address period and a sustain period; and
code for, in at least one of the plurality of sub-fields, sequentially performing the address period and the sustain period to each group in a manner that:
a) addressing of each group is performed and then the sustain period is performed in cells of each group subjected to addressing;
b) addressing of cells of a different group is performed after the sustain period ends; and
c) the sustain period is performed selectively in the cells of the different group subjected to addressing while the sustain period is performed in cells of a group,
wherein in at least one sustain period, high level potentials of the sustain discharge signal applied to the scanning electrode are the same in all the groups and the high level potentials of the sustain discharge signal are applied at the same time to all the groups; and
low level potentials of the sustain discharge signal are applied to the scanning electrodes include a first low level potential and a second low level potential, where the second low level potential is higher than the first low level potential.

24. The medium of claim 23, wherein the first low level and the second low level potentials are applied to each of the groups in different timings.

25. The medium of claim 23, wherein a discharge is carried out during an overlapping period of the first low level potential of the scanning electrode and a high level potential of the common electrode.

26. The medium of claim 23, wherein no discharge is carried out during an overlapping period of the second low level potential of the scanning electrode and the high level potential of the common electrode.

27. The medium of claim 23, wherein the second low level potential is equal to a potential difference between a high level potential and a low level potential of the scanning pulse applied to the scanning electrodes in the address period.

28. The medium of claim 23, wherein the sustain period further includes a common period for performing sustain discharges at the same time in all groups during a predetermined time.

29. A display panel driving apparatus which applies a scanning signal and a sustain discharge signal to a scanning electrode line of a display panel, the apparatus comprising:
a first mode;
a means for driving a sustain signal connected to the first mode;
a means for apply a high level scanning signal connected to the first mode;
a means for applying a low level scanning signal connected to the first mode;
a means for switching having one end connected to the means for applying a high level scanning signal;
a means for applying a low level scanning discharge signal;
a second means for switching connected between another end of the first means for switching and the means for applying a low level scanning discharge signal;
a third means for switching connected between another end of the first means for switching and the scanning electrode line; and
a fourth means for switching connected between the scanning electrode line and the means for applying the low level scanning signal.

30. A display panel driving method comprising the steps of:
driving a frame into a plurality of sub-fields, wherein, each of the plurality of sub-fields includes an address period and a sustain period;
in the address period, selecting cells to be displayed; and
in the sustain period, applying high levels and low levels of a sustain discharge signal alternately to scanning electrodes and common electrodes so to perform a sustain discharge;
wherein in at least one sustain period, the high level potentials of the sustain discharge signal applied to the scanning electrode are the same and the high level potentials of the sustain discharge signal are applied at the same time; and
low level potentials of the sustain discharge signal applied to the scanning electrodes include a first low level potential and a second low level potential higher than the first low level potential.

31. The method of claim 30, wherein the first low level and the second low level potentials are applied at different times.

32. The method of claim 30, wherein a discharge is carried out during an overlapping period of the first low level of the scanning electrode and a high level of the common electrode.

33. The method of claim 30, wherein no discharge is carried out during an overlapping period of the second low level potential of the scanning electrode and the high level potential of the common electrode.

34. The method of claim 30, wherein the second low level potential is equal to a potential difference between a high level potential and a low level potential of the scanning pulse applied to the scanning electrodes in the address period.
